(19) United States
(12) Patent Application Publication
(10) Pub. No.: US 2009/0007482 A1
(43) Pub. Date: Jan. 8, 2009

(54) Sulfur Evaporator

(75) Inventors: Peter Sewzyk, Paderborn (DE); Wolfgang Erdmann, Katlenburg-Lindau (DE)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ELSTEIN-WERK M. STEINMETZ GMBH & CO. KG, Northeim (DE)

(21) Appl. No.: 12/166,841

(22) Filed: Jul. 2, 2008

(30) Foreign Application Priority Data
Jul. 6, 2007 (DE) 10 2007 031 572.6

(51) Int. Cl. A01M 13/00; B01D 1/02

(52) U.S. Cl. 43/129; 422/307; 392/387

(57) ABSTRACT

A fumigation apparatus (1) includes a sulfur evaporator (3) including a heat source (28) and a container (9). The heat source (28) includes an electrically operated heating coil (15). The container (9) includes a wall (11) and an inner space (13). The inner space (13) is designed and arranged to store sulfur (14) to be evaporated therein. The container (9) substantially is made of ceramic material. The heat source (28) and the container (9) are designed as one common structural unit. The heating coil (15) at least partly is arranged in the wall (11) of the container (9) such that it is embedded in the ceramic material.

### CROSS REFERENCE TO RELATED APPLICATIONS

This application claims priority to co-pending German Patent Application No. DE 10 2007 031 572.6 entitled “Schwefelverdampfer”, filed Jul. 6, 2007.

### FIELD OF THE INVENTION

The present invention generally relates to a fumigation apparatus for evaporating sulfur.

More particularly, the present invention relates to a sulfur evaporator including a heat source being designed as an electrically operated heating coil which is embedded in a ceramic material. The apparatus further includes a container including an inner space for storing sulfur therein.

Usually, such apparatuses serve for evaporating pesticides, mixtures of pesticides and other remedies as they are used for fighting plant diseases. It is intended to bring the respective counter agent from the liquid form or solid form into vaporous form, and to distribute the vapor in a closed building, especially in a greenhouse. A main field of application for such apparatuses is the evaporation of sulfur, as it is especially used for fighting mildew occurring at roses, peppers, tomatoes and the like.

### BACKGROUND OF THE INVENTION

A known sulfur evaporator is distributed by Nivola B.V. located in The Netherlands. The known sulfur evaporator includes a housing made of metal which is designed as a tube section, meaning it is open in an upward and in a downward direction. The housing includes a hanger to hang up the evaporator at a respective place in a greenhouse. The housing in its lower portion includes a transverse carrier which is designed and arranged to leave the inner space of the housing open in a downward and an upward direction, and a socket to which electric energy is fed by a respective cable during operation of the evaporator. The socket is arranged at the housing in a stationary way. The sulfur evaporator includes a heat source which is designed as an infrared radiator, meaning a component which is substantially made of ceramic material and which has an approximately mushroom-like shape with a radiation surface which is oriented to be horizontal. A heating coil is embedded in the ceramic material of the infrared radiator. At the place of the surface of the infrared radiator below which the heating coil is located, there is a local protrusion such that the location of the heating coil is to be easily seen from the outside. The infrared radiator at its lower end includes a base which is coordinated with the socket such that it is possible to attain the electric connection to the heating coil by screwing. Another tube section is located within the housing, the tube section being arranged to be adjustable and to surround the infrared radiator. This tube section serves to support a pot-like container which is introduced with its overhanging edge into the height adjustable tube section. The pot-like container includes a bottom and a wall substantially extending in a vertical direction for the sulfur to be evaporated. The pot-like container is made of bare aluminum which does not have substantial insulating properties. The height adjustable tube section allows for adjustment in a way that the pot-like container made of aluminum can be arranged at different heights with respect to the surface of the infrared radiator. It is also possible that the pot-like container is directly located on the radiation surface of the infrared radiator.

The known sulfur evaporator by Nivola B.V. is operated with infrared radiators which have a power consumption of 80, 90 and 100 watt, respectively. In this way, it is possible to attain an evaporation output which is about 0.3 to 0.42 g/h. The temperatures of the heat source required for such an output are comparatively high, especially in a region between 300° C. and 500° C. The heat transfer between the infrared radiator and the pot-like container made of aluminum causes problems. On the one hand, it substantially depends on the distance between the surface of the infrared radiator and the bottom of the container. Even when the container is directly supported on the radiation surface of the infrared radiator, there are different contact surfaces for heat transfer. In the optimal case, the bottom of the pot-like container is designed to be flat such that when arranging the heating coil in one plane and respectively designing the infrared radiator at its radiation surface, there only is line contact between the ceramic material of the infrared radiator and the container made of aluminum in the shape of a spiral. In case the bottom of the pot-like container made of aluminum has been changed no longer to be flat, for example due to heat influence or mechanic deformation, the heat transfer is further deteriorated. Depending on the condition of the known sulfur evaporator, there will be undesired varying evaporation outputs. The user will try to compensate for these varying outputs by feeding as much electric energy to the infrared radiator as possible. This results in dangerous surface temperatures occurring at the infrared radiator which are substantially higher than the self-ignition temperature of the sulfur. If liquid sulfur gets in contact with such surface portions of the infrared radiator, the self-ignition temperature of the sulfur is exceeded such that there is a substantial danger of fire getting started in the greenhouse. If one reduces the power of the infrared radiator, the evaporating power is decreased.

Another known sulfur evaporator is distributed by HotBox International Ltd. The known sulfur evaporator includes a tube-like housing made of metal in which a heat source is located. The heat source is designed as a flat heating plate made of semiconductor material with a positive temperature coefficient. This special design of the heating plate has the advantage of power consumption being decreased when temperatures rise such that such a heating plate at its surface obtains temperatures which are in a range of 200° C. to 220° C. during operation, and which do not exceed this value range. A separate pot-like container made of bare aluminum is associated with the heat source. The container includes an inner space for the sulfur to be evaporated. The pot-like container is directly supported on the heating plate similar to a cooking pot on a hot plate. The evaporator includes a tube section which is designed to be adjustable with respect to its height. Changing the distance between the bottom of the container and the heating plate is not possible. The known sulfur evaporator advantageously prevents the self-ignition temperature of the sulfur from occurring, but it has the drawback of comparatively low evaporation output in a range of approximately 0.13 g/h. This output is associated with temperatures of the liquid sulfur to be evaporated in a range of approximately 130° C. to 140° C. This known sulfur evaporator also shows the drawback of mechanical or thermal changes of the pot-like container for holding the sulfur to be evaporated result in a change of the heat transfer between the heat source, the container and the sulfur to be evaporated. This causes irreproducible evaporation outputs. It is difficult to dimension sulfur evaporation in this known apparatus. Consequently, when using the known apparatus, one often operates with surplus sulfur evaporation which leads to the drawback of long aeration times for the greenhouse becoming necessary before it is possible to enter the greenhouse for working purposes.

Another sulfur evaporator is known from International Patent Application published as WO 2005 036 959 A2. The known sulfur evaporator includes a container and a heating plate which are designed as separate components. The container includes a bottom and a wall made of an aluminum alloy. The heating plate is made of a material which has good heat conductive properties. The container is put down on the heating plate. The heat source for producing heat is located below the heating plate. The inner surface of the container is increased by the arrangement of ribs, rings, and the like which extend substantially in a vertical direction. The spaces located between the ribs and the rings, respectively, are interconnected by channels such that the sulfur which first becomes liquid during evaporation is distributed in the inner space which has a smaller volume due to the ribs. The heat source is designed as a separate heating plate. The ribs, rings, and the like include a porous coating. The coating includes a multitude of holes which is intended to improve evaporation of the sulfur by osmosis. The known sulfur evaporator intends to increase the surface of the container. To further increase the surface, the ribs or rings may include semicircular impressions. In this way, the inner surface serving to transmit the heat onto the sulfur is maximized. In another embodiment, the distance between the heating plate and the bottom of the container is adjusted to obtain temperature control. When increasing the distance, heat transfer and evaporation output is decreased. This disadvantage can be compensated by increased heating. However, this also increases the danger of a fire getting started in the greenhouse. It is another drawback that the heat of the heating plate has to be guided to the respective locations of the container including the rings and ribs, respectively, over far away paths of different lengths. This will presumably result in different conditions and different local temperatures which do not result in efficient evaporation of sulfur.

An apparatus for producing pleasant smell by evaporating flavors is known from German Gebrauchsmuster DE 94 06 568 U1.

An apparatus for evaporating chemicals, as for example pesticides, is known from Swiss Patent Application No. CH 344 182 A.

An evaporator for evaporating solid and liquid materials, such as for example pesticides, is known from Swiss Patent Application No. CH 306 572 A.

An electric appliance for home use, for example an egg boiler or a coffee machine, is known from Austrian Patent No. AT 332 948 B corresponding to British Patent Application No. GB 1 501 424.

### SUMMARY OF THE INVENTION

The present invention relates to a sulfur evaporator. The sulfur evaporator includes a heat source and a container. The heat source includes an electrically operated heating coil. The container includes a wall and an inner space. The inner space is designed and arranged to store sulfur to be evaporated therein. The container substantially is made of ceramic material. The heat source and the container are designed as one common structural unit. The heating coil at least partly is arranged in the wall of the container such that it is embedded in the ceramic material.

The present invention also relates to a fumigation apparatus for evaporating sulfur. The fumigation apparatus includes a sulfur evaporator as described above and a housing in which the sulfur evaporator is located.

The sulfur to be evaporated has certain typical properties. In most cases, solid sulfur, for example in the form of pellets or powder, is used. The sulfur changes from its solid state of aggregation into the liquid state of aggregation at approximately 119° C. It is to be understood that a further increase in temperature is necessary for realizing the evaporation, meaning the transition from the liquid into the vaporous state of aggregation. During this temperature increase, viscosity and/or color of the sulfur change. In a temperature range which is approximately between 230° C. and 260° C., the sulfur attains its self-ignition temperature which substantially increases the danger of greenhouse fires. On the one hand, it is desired to prevent this temperature range. On the other hand, it is desired to attain great evaporation outputs which are only possible if the temperature of the liquid sulfur is respectively increased.

The novel sulfur evaporator provides for high evaporation power of approximately 0.4 g/h or more without the danger of self-ignition of the sulfur.

The novel sulfur evaporator includes a heat source and a container for the sulfur to be evaporated. The heat source and the container are designed as one common structural unit, meaning as one piece. This one piece is substantially made of ceramic material. The novel sulfur evaporator substantially differs from the ones known in the prior art in which the heat source and the container are designed as two separate pieces. The prior art more or less is influenced by the image of a cooking pot being placed upon a hot plate in a normal kitchen. The novel sulfur evaporator now leaves this concept.

Usually, the novel sulfur evaporator also additionally includes a housing made of metal being designed as a tube section surrounding the inner part including the heat source and the inner space being designed as one piece. The evaporator includes an annular passage space which extends from the lower region towards the upper region by which a chimney effect is attained. This means that air from below (for example in a greenhouse) is sucked in, the air distributing the vaporous sulfur in the greenhouse. Due to the heat source and the inner chamber being designed as one piece, heat transfer and heat transmission are reproducible and more even such that one attains reliable reproducible conditions when evaporating sulfur. In this way, a portioning of sulfur with respect to the plants located in the greenhouse can be better controlled.

The novel sulfur evaporator may also be designed as a safety evaporator in which the surface temperature of the inner space of the container is limited by respective coordination of the electric power consumption of the heating coil such that the self-ignition temperature of the sulfur is not reached. Thus, the danger of a fire in the greenhouse getting started as a result of the sulfur evaporator is widely eliminated.

The novel sulfur evaporator is capable of realizing high evaporation outputs in a range of approximately 0.4 g/h to approximately 1 g/h. This is possible while realizing less power consumption as known in prior art sulfur evaporators. Power saving may be in a range of approximately 50 watt. Thus, the novel sulfur evaporator can be operated at lower costs compared to prior art sulfur evaporators.

Another advantage of the novel sulfur evaporator is the fact that the heating surface is increased compared to sulfur evaporators known in the prior art. The heating surface is not arranged in a plane which is approximately parallel to the bottom of the pot-like container, but instead the heating surface is located in the component being designed as one piece, the component including the electrically driven heating coil as well as the inner space for the sulfur to be evaporated. The prior art evaporators do not use the wall of the pot-like container for transmitting substantial amounts of energy. In contrast, the novel sulfur evaporator makes substantial use of the wall of the container for heating the inner space. Especially, the wall extends in a vertical direction in a cylindrical shape or in a conical shape. In this way, one attains an advantageously increased surface compared to the circular surface known in the prior art. However, the inner space may also include a bottom, and a part of the heating coil may also be located in the region of the bottom. Anyway, the total heating surface is increased by using the wall of the container which results in a decrease of the heating power to be provided at the same or even increased evaporation output compared to the prior art.

The novel sulfur evaporator may have a shape and dimensions which are chosen such that it is possible to replace and retrofit existing sulfur evaporators. For this purpose, it makes sense, for example, to design the novel sulfur evaporator to include a socket including a thread, as it is generally known in usual light bulbs. Due to the fact that the inner space for the sulfur is now made of ceramic material, there are no dimensional changes which could have a negative effect with respect to heat transmission. The heating coil may be located as close as possible to the inner wall of the inner space. However, it is preferred if this is realized in a way without the ceramic mass having a convex shape. Consequently, the heating coil cannot be seen when visually expecting the novel sulfur evaporator.

The novel sulfur evaporator is an important element of a sulfur evaporation apparatus additionally including a housing. In this way, the novel sulfur evaporator also attains the advantageous desired chimney effect for realizing the airflow distributing the vaporous sulfur.

The sulfur to be evaporated may be introduced into the inner space in the form of pellets or as powder. Due to the fact that the inner chamber is permanently arranged in the container, the inner chamber cannot be removed from the container. In this way, additional sources of errors are eliminated. Due to the fact that no bush being adjustable with respect to its height is required, the novel apparatus can be produced at lower costs compared to the prior art.

It is preferred that the essential elements of the safety evaporator are made of ceramic material. The heating coil is at least partly located in the wall of the container. In case the container does not have a real bottom, this means that the heating coil is at least located in the wall of the container. However, in case the container has a real bottom, the heating coil may also be located at least in a part of the bottom. The arrangement of the heating coil in the wall of the container may be chosen such that it differs along the height to coordinate it to the level of the liquid sulfur in the inner space which diminishes during continued evaporation.

The novel sulfur evaporator at its upper end (as seen in the upright working position of the evaporator) includes the inner space for the sulfur to be evaporated, the inner space being designed to be open in an upward direction. At its lower end, the sulfur evaporator includes a fixing means which is coordinated with a respective counter fixing means. For example, the fixing means is designed as a socket including a thread, a clamping socket, and the like.

The novel sulfur evaporator may be designed to be elongated and as a component mainly extending in a vertical direction in its upright working position. It is advantageous if the container includes a hollow space between the inner space and the fixing means. For example, this hollow space serves to attain low temperatures in the region of the fixing means, the temperatures being well below the self-ignition temperature of the sulfur. In this way, the danger of fire is also eliminated at this place if liquid sulfur unintentionally gets in contact to the fixing means. The hollow space serving for insulation purposes may be completely or partly filled with an insulating material to further improve thermal insulation.

It is preferred that the novel sulfur evaporator has an electrical design such that the heat source has a power density in a region of approximately 0.7 to 1.1 watt/cm². A power density in a range of approximately 1 watt/cm² has been found to be especially advantageous. Such a value is sufficient to attain high evaporation outputs as they have not been possible until now.

The container made of ceramic material at its lower end as seen in the upright operating position may include a dripping edge which protrudes in an axial direction. The dripping edge extends axially beyond the edge of the socket protruding in an upward direction. In this way, surplus sulfur in liquid form cannot enter the socket. Such surplus sulfur may result from the inner space being overfilled with sulfur and/or undesired transverse arrangement of the housing or when hitting upon the apparatus and thus causing a respecting displacement of the housing. This feature is an additional safety measurement for reducing and eliminating, respectively, the danger of fire.

The container can be designed to be conical in a way that its lower end diminishes in a downward direction as seen in the upright operating position of the evaporator. In this way, the inner space at the upper end may be designed to be respectively greater. There is a continuously changing cross-section between the outer wall of the conical container and the inner wall of the housing of the evaporator which additionally supports the chimney effect. It also results in turbulence of the moved air such that the sulfur which is evaporated is securely carried away and distributed. However, this does not mean that the container may also have a different design, for example a cylindrical, cup-like or mushroom-like design.

It is preferred if the container especially in the region of the inner space includes a glazing to design the surface of the body of ceramic material impervious to prevent sulfur from entering into the ceramic material. However, it is also possible to protect the entire surface of the container, meaning including its outer surface, by a glazing.

It is preferred if the inner space of the container (if this includes a bottom) has a flat surface in the region of the bottom. This design is in contrast to the design of the upper surface of an infrared radiator as known in the prior art onto which a pot-like container is put. The heating coil is deeply embedded in the material of the container such that its position cannot be seen from the outside.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a longitudinal sectional view through a first exemplary embodiment of the novel apparatus including a housing and a sulfur evaporator.

FIG. 2 is a longitudinal sectional view of a second exemplary embodiment of the novel sulfur evaporator.

FIG. 3 is a view of the sulfur evaporator of FIG. 2 in a position rotated by 90°.

FIG. 4 is a longitudinal sectional view through a fourth exemplary embodiment of the novel sulfur evaporator.

FIG. 5 is a longitudinal sectional view through a fifth exemplary embodiment of the novel sulfur evaporator.

### DETAILED DESCRIPTION

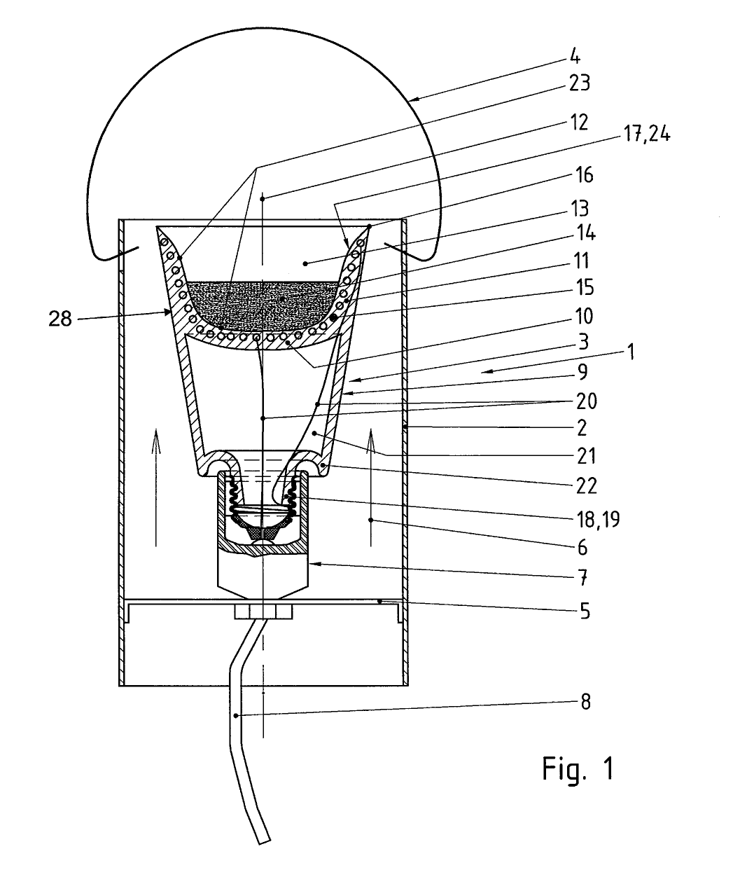

Referring now in greater detail to the drawings, FIG. 1 illustrates a novel apparatus 1 including a housing 2. A sulfur evaporator 3 is arranged in the housing 2. The housing 2 is formed by tube sections made of metal which have an annular cross-section. The tube sections are designed to be open in an upward and a downward direction. A hanger 4 is located in the upper portion of the housing 2, and it serves to locate the apparatus 1, mostly in a greenhouse, by hanging. A transverse carrier 5 is fixedly located to the housing 2. The transverse carrier 5 has the design of a star or a bridge. The transverse carrier 5 only partly blocks the inner cross-section between the fumigation apparatus 3 and the inner wall of the housing 2 to allow for chimney-like airflow according to arrow 6 during operation of the apparatus 1. A socket 7 is located at the transverse carrier 5 in a stationary way. Power supply to the socket 7 is realized by a usual electric cable 8. The entire apparatus 1, meaning including the sulfur evaporator 3 and the housing 2, is designed as a salable unit.

The sulfur evaporator 3 or fumigation apparatus 1 for sulfur includes a pot-like container 9 made of ceramic material. The container 9 in its upper portion includes a bottom 10 and a wall 11. The bottom 10 is more or less designed and arranged to be horizontal, but it may also be designed to be slightly deepened as illustrated. The wall 11 substantially extends in a vertical direction, meaning approximately cylindrical or conical with respect to a center axis 12. The bottom 10 and the wall 11 define an inner space 13 for storing sulfur therein.

The sulfur evaporator 3 further includes a heat source 28. The heat source 28 is designed as an electric heating coil 15. The heating coil 15 is embedded in the ceramic material of the bottom 10 and of the wall 11 of the container 9. It is to be understood that the inner space 13 is designed to be open in an upward direction to allow for the sulfur 14 (which is respectively heated) to exit in an upward direction in vaporous form. The vaporous sulfur is then further transported by the airflow according to arrow 6 by the chimney effect occurring in the annular cross-section between the housing 2 and the outer limitation of the container 9. The wall 11 at its upper end includes a slim edge 16 to improve the possibility of introducing the sulfur into the inner space 13 when filling the fumigation apparatus 3 and to prevent the sulfur from being accidentally located in the region of the edge 16. On the other hand, such a design also improves transfer of the sulfur vapor into the airflow being directed in an upward direction. The heating coil 15 is designed as the heat source 28 of the sulfur evaporator 33. The heating coil 15 is embedded into the ceramic material of the bottom 10 and of the wall 16 such that there is a smooth inner wall 17. In other words, the heating coil 15 cannot be seen when looking into the inner space 13.

At the lower end of the container 9, the ceramic material of the container 9 is permanently provided with a fixing means 18. In the present example, the fixing means 18 is designed as a base 19 having a known design. The base 19 is designed to correspond to the socket 7 in a way that the container 9 and the fumigation apparatus 3, respectively, can be inserted into the socket 7 by screwing. Connecting lines 20 lead from the base 19 to the heating coil 15. The connecting lines 20 serve to supply electric energy to the heating coil 15 via the cable 8 or wire.

In the preferred exemplary embodiment illustrated in FIG. 1, the container 9 made of ceramic material has a shape which substantially is similar to the one of a truncated cone the diameter of which diminishes in an upward direction. A hollow space 21 is located in the container 9 between the bottom 10 and the inner space 13, respectively, and the fixing means 18. The hollow space 21 serves for insulating purposes. On the one hand, it is desired to attain a sufficiently high temperature in the sulfur 14 to be evaporated in the region of the bottom 10 and of the wall 11. On the other hand, it is desired that the fixing means 18 still has a substantially lower temperature even during full operation to prevent liquid sulfur which has accidentally reached the socket 7 from reaching its self-ignition temperature. In this way, the danger of a fire getting started at this place is eliminated. Another safety feature is that the container 9 in its lower end portion includes a dripping edge 22 extending over the upper end of the socket 7 in an axial direction. The edge 22 allows for liquid sulfur which accidentally flows down at the outer circumference of the container 9 (for example if the apparatus 1 is suspended in an inclined way) to drip down without reaching the socket 7. At this place, the hollow space 21 is filled with air, and it is connected to the atmosphere.

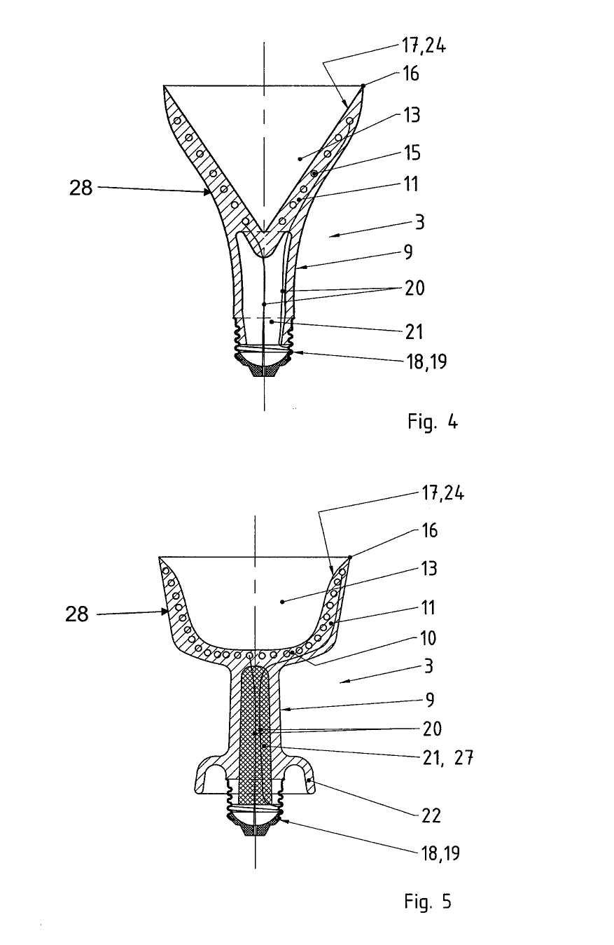

The inner space 13 for the sulfur 14 to be evaporated is defined by the bottom 10 and the wall 11. It is to be seen that the heating coil 15 is deeply embedded in the ceramic material such that one attains a smooth continuous outer surface 23. The surface 23 of the container 9 which surrounds the inner space 13 includes a glazing 24 which prevents the sulfur from entering the ceramic material of the container 9. It is also possible that the outer surface of the container 9 includes such a glazing 24. It is to be seen from the arrangement of the heating coil 15 that the wall 21 substantially extending in a vertical direction provides a comparatively greater surface for heat generation and heat transfer compared to the bottom 10. The wall 11 forms an approximately cylindrical or (truncated) conical surface, while the bottom 10 provides an annular surface. Depending on the design of the inner space 13, the bottom 10 may also have a comparatively small surface amount, or it may be completely eliminated (see FIG. 4) such that heat generation substantially takes place in the wall 11.

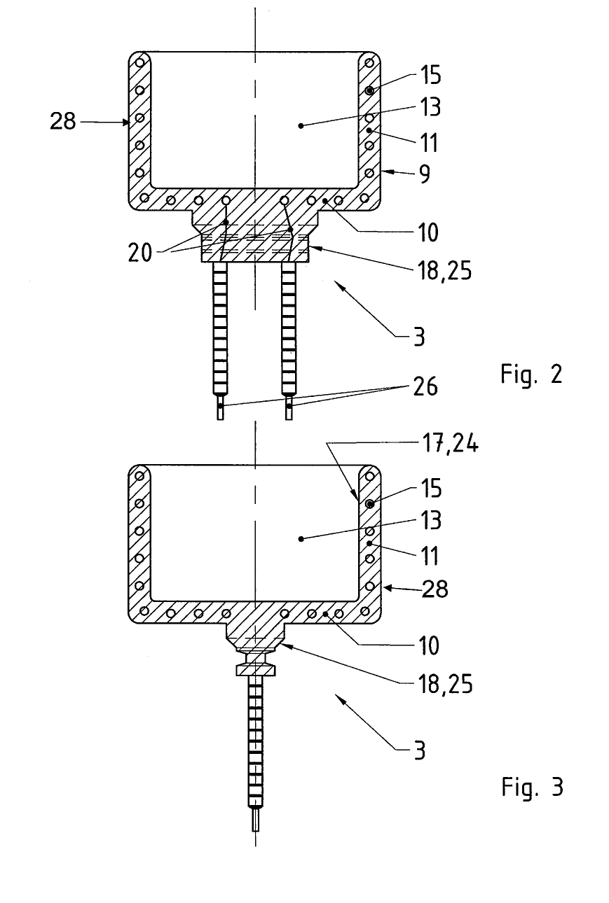

FIGS. 2 and 3 illustrate a second exemplary embodiment of the novel sulfur evaporator 3. It is to be understood that the sulfur evaporator 3 may also be arranged in a housing 2 as illustrated in FIG. 1. The container 9 has a design similar to a pot, and it includes the bottom 10 substantially extending in a horizontal direction and the cylindrical wall 11. The heating coil 15 is arranged in the bottom 10 and in the wall 11. In this way, the inner space 13 for the sulfur (not illustrated) is formed. Compared to the embodiment of the apparatus 3 illustrated in FIG. 1, the container 9 has a smaller height. The fixing means 18 is designed as a clamping base 25, and it is directly located below the bottom 10, meaning without an arrangement of a hollow space 21 (FIG. 1). The design of such a clamping base 25 is known from infrared radiators. Instead of an electric cable, the apparatus 3 uses two insulated lines 26 serving to provide electric energy to the heating coil 15 via the connecting lines 20. A comparison of FIGS. 2 and 3 makes it possible to recognize the elongated shape of the clamping base 25.

In the exemplary embodiment of the novel apparatus 3 illustrated in FIG. 4, the container 9 has a slim outer surface which is similar to the shape of a tulip. The inner space 13 is practically only surrounded by the wall 11, meaning there is no actual bottom 10. This design makes use of the comparatively great surface of the wall 11 for arranging the heating coil 15 in an optimal way. The inner space 13 has a triangular cross-section.

The exemplary embodiment of the novel apparatus 3 illustrated in FIG. 5 includes a container 9 which has a shape which is similar to a cup. The hollow space 21 is filled with an insulating material 27. The dripping edge 22 is designed in a distinctive way, and it extends comparatively far beyond the socket 19 in an axial direction.

Many variations and modifications may be made to the preferred embodiments of the invention without departing substantially from the spirit and principles of the invention. All such modifications and variations are intended to be included herein within the scope of the present invention, as defined by the following claims.

We claim:

1. A sulfur evaporator, comprising:
a heat source, said heat source including an electrically operated heating coil; and
a container, said container including a wall and an inner space, said inner space being designed and arranged to store sulfur to be evaporated therein, said container substantially being made of ceramic material,
said heat source and said container being designed as one common structural unit,
said heating coil at least partly being arranged in said wall of said container such that it is embedded in the ceramic material.

2. The sulfur evaporator of claim 1, wherein said container includes a bottom, said bottom being made of ceramic material, a part of said heating coil being arranged in said bottom.

3. The sulfur evaporator of claim 1, wherein said container at its one end includes said inner space for the sulfur to be evaporated, said inner space being designed to be open in an upward direction, and said container at its other end includes a fixing means.

4. The sulfur evaporator of claim 3, wherein said container includes a hollow space, said hollow space being located between said inner space and said fixing means.

5. The sulfur evaporator of claim 4, wherein said hollow space is filled with an insulating material.

6. The sulfur evaporator of claim 1, wherein said heat source has a power density of between approximately 0.7 to 1.1 watt/cm².

7. The sulfur evaporator of claim 1, wherein said heat source has a power density of approximately 1 watt/cm².

8. The sulfur evaporator of claim 1, wherein said container has a lower end as seen in a working position of said sulfur evaporator, said lower end including a dripping edge, said dripping edge being designed and arranged to protrude in an axial direction.

9. The sulfur evaporator of claim 1, wherein said container has a lower end as seen in a working position of said sulfur evaporator, said container in a direction towards said lower end having a conical shape which diminishes towards said lower end.

10. The sulfur evaporator of claim 1, wherein said container includes a glazing.

11. The sulfur evaporator of claim 1, wherein said container in the region of said inner space includes a glazing.

12. The sulfur evaporator of claim 1, wherein said container includes a bottom, said bottom being designed and arranged to have a flat surface.

13. A fumigation apparatus for evaporating sulfur, comprising:
a sulfur evaporator, said sulfur evaporator including
a heat source, said heat source including an electrically operated heating coil, and
a container, said container including a wall and an inner space, said inner space being designed and arranged to store sulfur to be evaporated therein, said container substantially being made of ceramic material,
said heat source and said container being designed as one common structural unit,
said heating coil at least partly being arranged in said wall of said container such that it is embedded in the ceramic material; and
a housing, said housing being designed as a tube section and to be open in an upward direction and in a downward direction,
said sulfur evaporator being arranged in said housing.

14. The fumigation apparatus of claim 13, wherein said tube section has an annular cross-section.

15. The fumigation apparatus of claim 14, wherein said container includes a bottom, said bottom being made of ceramic material, a part of said heating coil being arranged in said bottom.
